(19) United States
(12) Patent Application Publication
(10) Pub. No.: US 2004/0031159 A1
(43) Pub. Date: Feb. 19, 2004

(54) Expandable knife holder

(76) Inventors: Gayle Rosenberg, Secaucus, NJ (US); Eli Pine, Secaucus, NJ (US)

Correspondence Address: ELI S. PINE, 827 HARMON COVE TOWERS, SECAUCUS, NJ, 07094, US

(21) Appl. No.: 10/218,147

(22) Filed: Aug. 14, 2002

(51) Int. Cl. B26B 27/00

(52) U.S. Cl. 30/298.4

(57) ABSTRACT

This invention, the Expandable Knife Holder, is a container within a container having knife slots that are sequentially and concurrently aligned such that knives can pass into slots of both containers and are thus held in place by the knife slots. By way of adding more knives should it be deemed necessary, the inner container can be pulled from within the outer container exposing additional knife slots. Both containers have slots that are incrementally synchronized and aligned such that when the containers are closed together the knives will fit into the slots of both containers simultaneously, and when they are apart, knives will fit in the slots of one or the other, or both simultaneously.

### BACKGROUND OF THE INVENTION

In many kitchens knives are held semi upright in the slots of a knife holder. Sometimes it is required that additional knives be added to the ones originally installed in the knife holder. If the slots are already filled there will not be room for more knives. Thus it may either be necessary to buy another knife holder or store the additional knives in a drawer, neither of these choices may be aesthetically or practically desirable. This invention is a knife holder that allows space for additional knives by having the ability for the holder to expand. There is a relatively hollow box, within which is another box. Both boxes have slots for holding knives in which the spacing of the slots are synchronized such that as the inner box is extended out from the outer box the slots from both boxes match sequentially and are concurrent so that more slots are available to retain knives. The knife blades pass through the slots and the knife handles rest on the slots of the outer box, the inner box, or both simultaneously. In this example the unexpanded knife holder contains 8 slots, while in the expanded stage the knife holder extends to 14 slots.

### SUMMARY OF THE INVENTION

This invention, the Expandable Knife Holder, has the ability to expand such that the number of slots available to hold knives in the knife holder can be increased incrementally and made available for more knives. The knife holder is a hollow box with knife slots into which fits another hollow box with knife slots. Each has knife slots that are arranged so that as the inner box is incrementally extended out from the outer box, the slots of the inner box match perfectly, and is in conjunction with those of the outer box no matter how far extended. In this example, in the non-extended stage, there are 8 slots. In the semi extended stage there are slots for 10, and 12 knives, while in the extended stage, in which the inner box is fully extended from the outer box, there are 14 slots available for knives.

### BRIEF DESCRIPTION OF THE DRAWINGS

In FIG. 1 the knife holder is partially extended from its full length. A knife protrudes through one of the slots (4) of the outer box (2) and a knife protrudes through a slot in the inner hollow box (1). A finger hole (3), can be used to slide the inner box from within the outer box. For convenient viewing the knife holder rests on an angle (5) from that of a kitchen table.

FIG. 2 shows only 2 extra slots are available from the inner box.

FIG. 3 shows 6 extra slots made available by pulling out the inner box even more

FIG. 4 shows the inner box fully pulled out and away from the outer box.

FIG. 5 shows the inner and outer boxes on their sides. The finger holes are square in shape, the knife slots are in the immediate foreground, and the rest angle of the knife holder is on the top left and right of the boxes.

### DESCRIPTION OF THE PREFERRED EMBODIMENTS

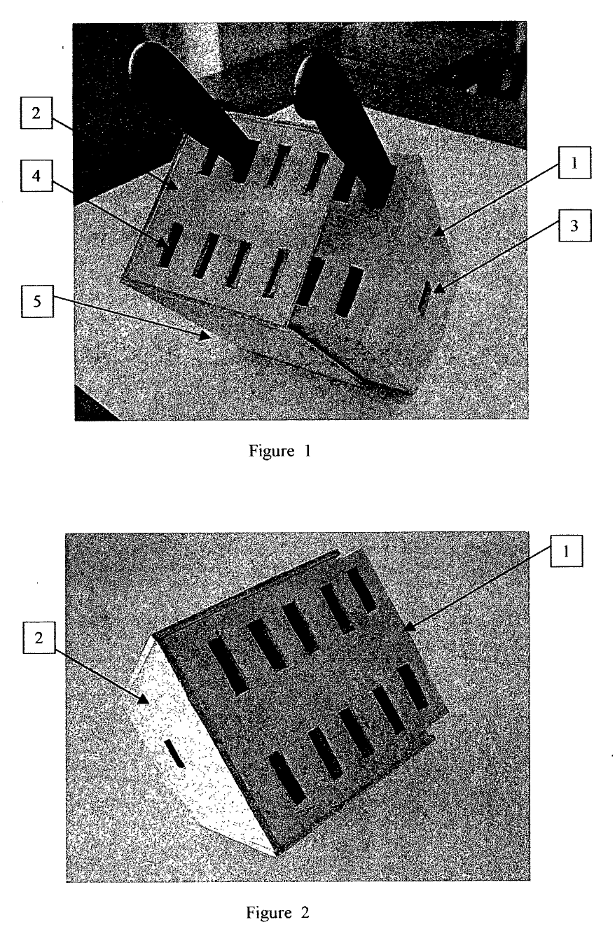

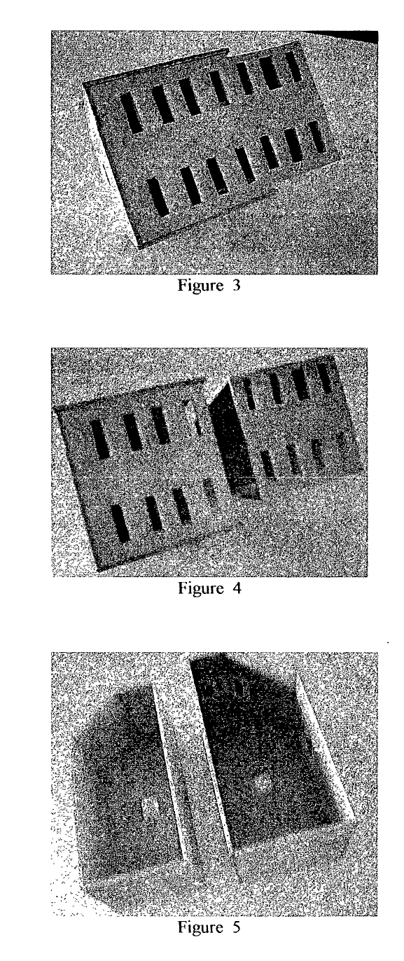

A kitchen knife holder is generally a wooden block (2) in which knives rest inside knife slots (4). There are occasions when all the knife slots are being used, yet more knives are desired to those already there. In that case another knife holder would be bought and added to the first knife holder, or the new knives might be put in a drawer. Neither of these choices may prove to be acceptable to the consumer. This invention, the Expandable Knife Holder, is expandable so that more knives can be included in the same knife holder with the original collection of knives. The Expandable Knife Holder is a relatively hollow box (1) within a larger relatively hollow box (2) the slots of the smaller hollow box, as the box is pulled out of the larger hollow box, are in conjunction with and match those of the larger hollow box (FIG. 1). Therefore the Expandable Knife Holder is expandable by increments (FIGS. 2,3,4), i.e. the expansion proceeds not more than is needed at the time. The inner box (FIG. 2) shows only 2 extra slots made available by one increment of extension. FIG. 1 shows 4 extra slots made available by the next increment of extension. FIG. 3 shows 6 extra slots made available by the next increment of extension. Indeed there may yet be a third or more hollow boxes in the smaller hollow box for even greater expandability, and therefore more room for knives and the like in the same Expandable Knife Holder.

1. We claim a relatively hollow box, with one side, or more sides capable of withdrawing a smaller box within, telescopically, and that both boxes have slot holes in their faces, such that the faces are one beneath the other and parallel to each other, and the slots are incrementally spaced on the face of each box such that the slots of both are in conjunction with one another when the inner box is incrementally being pulled from without of the outer box, and both boxes have another side such that they are in a tilted position when resting on a flat surface, and that a third or more boxes rest within the inner box with the same capability of having slots on their faces, the slots being parallel and one under the other such that as they are being pulled from within the outer box the slots on their faces are in conjunction with and aligned with the slots above such that at each increment of extension the slots are in conjunction with and aligned with the slots above and below as the case may be and the slots are equitably spaced so as to accommodate whatever use, in this case holding knives, they made be put to, and that the sides of the boxes may be curved such that the inner boxes may be extended in a circular direction and that the inner boxes may be extended in any direction including vertical or horizontal and that the slots, generally rectangular in shape, can be of any shape and size, and that one or more slots may be intentionally misaligned with those above.

2. We claim a flat surface having slot holes through the surface with one or more flat or curved surfaces beneath having slot holes in conjunction with those above such that as one surface moves incrementally with respect to the other, generally in a sliding direction, the slots of those surfaces below are in conjunction with those above such that a materials, such as a rods or knives can be inserted through a set of the holes of surfaces and that the slot holes are in a purposeful sequence such that at each increment of parallel movement of separation of the surfaces, the slot holes do generally line up.

3. We claim a set of boxes, generally with or without flat surfaces, one within the other whose shapes and dimensions are such that at least one box surface is parallel to the other(s) and of the parallel surfaces contains slot holes that are in conjunction with another surface such that the slot holes of one surface coincides with another one atop the other such that at each interval of respective lateral length apart, as the inner boxes are incrementally moved outward of the larger boxes, the slot holes of the surfaces of the boxes coincide and are in conjunction with one another.

4. We claim a set of relatively hollow boxes with slots as described above that has a flat plane set at an angle of approximately 45 degrees from that of a flat kitchen table so that the boxes can be set at that angle and the knives be more conveniently seen and used, and that the boxes have side holes that a finger can fit into as might be needed to more easily pull apart the boxes.
